(19) United States
(12) Patent Application Publication
(10) Pub. No.: US 2024/0405439 A1
(43) Pub. Date: Dec. 5, 2024

(54) METASURFACE-BASED DUAL-BAND POLARIZED TWO-BEAM BASE STATION ANTENNA

(71) Applicant: SOUTH CHINA UNIVERSITY OF TECHNOLOGY, Guangzhou (CN)

(72) Inventors: Wenquan CHE, Guangzhou (CN); Wanchen YANG, Guangzhou (CN); Lizheng GU, Guangzhou (CN); Quan XUE, Guangzhou (CN)

(21) Appl. No.: 18/572,505

(22) PCT Filed: Oct. 29, 2020
(86) PCT No.: PCT/CN2020/124569

§ 371 Date: Aug. 13, 2024

(30) Foreign Application Priority Data
Mar. 13, 2020 (CN) 202010177545.5

(51) Int. Cl. H01Q 15/02; H01Q 1/24; H01Q 13/10; H01Q 21/24; H01Q 25/00

(52) U.S. Cl. CPC H01Q 15/02; H01Q 1/246; H01Q 13/10; H01Q 21/24; H01Q 25/001

(57) ABSTRACT

A metasurface-based dual-band polarized two-beam base station antenna includes a radiation metasurface antenna layer, a metal floor etched with a plurality of crossed slots, and a four-port feed network layer; the radiation metasurface antenna layer is positioned on an uppermost layer, the four-port feed network layer is positioned on a lowermost layer, the metal floor is arranged between the radiation metasurface antenna layer and the four-port feed network layer, and the plurality of crossed slots are etched on the metal floor to achieve a dual-band polarized radiation characteristic; and the plurality of crossed slots are sequentially excited, and energy of the four-port feed network layer is coupled to the radiation metasurface antenna layer via the crossed slots, so as to realize dual-band polarized beams.

### TECHNICAL FIELD

The present invention relates to the field of dual-band polarized base station antennas, in particular to a metasurface-based dual-band polarized two-beam base station antenna.

### BACKGROUND

With the development of modern wireless communication technology, the communication capacity of base stations is facing severe challenges. Dual-band polarized two-beam antennas may transmit data by means of polarization diversity and beam diversity, which effectively improves the communication capacity of the base stations. However, antenna arrays and beamforming networks need to be separately designed for conventional dual-band polarized two-beam antennas (Zhang X Y, Xue D, Ye L, et al. Compact Dual-Band Dual-Polarized Interleaved Two-Beam Array with Stable Radiation Pattern Based on Filtering Elements [J]. IEEE Transactions on Antennas and Propagation, 2017:4566-4575). The use of the beamforming networks will bring many problems of higher insertion loss, huge size, complex design and the like. In particular, complex phase shift networks need to be designed to ensure the consistency of beam deflection angles in working bandwidths. This brings great challenges to the overall design of antenna arrays and is not suitable for antenna design in compact environments.

In recent years, highly concerned metasurface antennas using periodic or aperiodic subwavelength patch elements may achieve wider bandwidth and better radiation properties while achieving low profile, and have been widely studied in the application of multiple bands and broadside arrays, but few studies involve dual-band polarized two beams.

### SUMMARY OF THE INVENTION

### Solution to Problems

### Technical Solution

To overcome the shortcomings and deficiencies existing in the prior art, the present invention provides a metasurface-based dual-band polarized two-beam base station antenna. The present invention has the characteristics of low insertion loss, high efficiency, small size, and simple structure, and can ensure that a beam has a stable and controllable deflection angle in a working band and under the condition of dual-band polarization.

The objective of the present invention is at least achieved by one of the following technical solutions:

A metasurface-based dual-band polarized two-beam base station antenna includes a radiation metasurface antenna layer, a metal floor etched with a plurality of crossed slots, and a four-port feed network layer; the radiation metasurface antenna layer is positioned on an uppermost layer, the four-port feed network layer is positioned on a lowermost layer, the metal floor is arranged between the radiation metasurface antenna layer and the four-port feed network layer, and the plurality of crossed slots are etched on the metal floor to achieve a dual-band polarized radiation characteristic; and the plurality of crossed slots are sequentially excited, and energy of the four-port feed network layer is coupled to the radiation metasurface antenna layer via the crossed slots, so as to achieve dual-band polarized beams.

Further, a radiation patch structure is printed on an upper surface of the radiation metasurface antenna layer, and the radiation patch structure includes a plurality of metasurface elements; the metasurface elements adopt square patches, rectangular patches or cross patches; and the metasurface elements are arranged periodically or aperiodically.

Further, in the metal floor, a spacing between adjacent two of the crossed slots is equal, and a size and shape of each of the crossed slots may be different and are selected as needed to adjust impedance matching and beam characteristics.

Further, a four-port feed network is arranged in a middle of the four-port feed network layer; the four-port feed network includes four input ports and mutually crossed transmission lines; a first input port and a second input port are respectively placed at two ends of the four-port feed network and respectively correspond to two deflected beams of one polarization, and a third input port and a fourth input port are respectively placed at two ends of the four-port feed network and respectively correspond to two deflected beams of another orthogonal polarization; a part of the transmission lines of the four-port feed network between the slots is provided with a bent structure; and the bent structure is adjusted according to a beam deflection angle, one metal bridge joint is arranged at an intersection of the transmission lines of the four-port feed network, the metal bridge joint is rotationally symmetrical about the intersection of the transmission lines, and two metal half through holes are provided in two ends of the metal bridge joint for signal transmission.

Further, symmetrically distributed metal through holes are provided around the crossed slots, and the metal through holes are connected to a lower bottom surface of the metal floor and a lower bottom surface of the four-port feed network layer.

Further, the transmission lines of the four-port feed network adopt microstrip lines, striplines, or substrate integrated waveguide transmission structures.

Further, polarization corresponding to the four input ports arranged in the four-port feed network includes ±45° linear polarization or vertical/horizontal linear polarization.

Further, the number of crossed slots on the metal floor is adjusted freely as needed; when no more than five slots are used, the antenna has the advantage of miniaturization under the condition of ensuring the dual-band polarized two-beam property; and when more than five slots are used or when arranged in array, the antenna has the advantages of high isolation, narrow beam, and high gain under the condition of ensuring the dual-band polarized two-beam property.

Further, both the radiation metasurface antenna layer and the four-port feed network layer adopt printed circuit board (PCB) dielectric substrates.

### Beneficial Effects of the Invention

### Beneficial Effects

Compared to the prior art, the present invention has the following beneficial effects:

(1) The present invention includes the plurality of metasurface elements, the plurality of crossed slots, and the four-port stripline feed network. Because the network is formed by the simple metasurface elements and the dual-band polarized beams, the control and consistency of the beam deflection angle in the working band are achieved, and the present invention has the advantages of compact structure and simple design.

(2) The present invention has the radiation characteristic of high front-to-back ratio by adopting the stripline feed network.

(3) The present invention realizes the dual-band polarized radiation characteristic by adopting the metasurface elements rotated 45°.

(4) The present invention realizes a characteristic of dual-band polarized excitation by adopting the four-port stripline feed network with a spiral plane and the plurality of crossed slots coupled to each other.

(5) The feed network in the present invention deflects the beam by controlling a cycle of the slot and a length of a folding part of the stripline, and may flexibly realize the forward or backward radiation of the beam.

(6) The feed network in the present invention realizes a characteristic of lower cross polarization level by loading the metal through holes around the crossed slots.

(7) The feed network in the present invention may realize the consistency of the beam deflection angle in the working band.

(8) The present invention is simple in structure, easy to process, and lower in cost and weight. Therefore, the present invention may be produced on a large scale.

### BRIEF DESCRIPTION OF DRAWINGS

FIG. 1a is a schematic three-dimensional structural diagram of a dual-band polarized two-beam base station antenna in an embodiment 1 of the present invention;

FIG. 1b is a schematic cross-sectional view of the dual-band polarized two-beam base station antenna in the embodiment 1 of the present invention;

FIG. 2a is a top view of an upper surface of a radiation metasurface antenna layer in the embodiment 1 of the present invention;

FIG. 2b is a bottom view of a lower surface of the radiation metasurface antenna layer in the embodiment 1 of the present invention;

FIG. 2c is a top view of an upper surface of a metal floor in the embodiment 1 of the present invention;

FIG. 2d is a top view of a stripline layer of a four-port feed network in the embodiment 1 of the present invention;

FIG. 2e is a bottom view of a lower surface of a four-port feed network layer in the embodiment 1 of the present invention;

FIG. 3 is a schematic diagram of an S parameter of the dual-band polarized two-beam base station antenna in the embodiment 1 of the present invention;

FIG. 4 is a yoz plane pattern of the dual-band polarized two-beam base station antenna at 4.9 GHz in the embodiment 1 of the present invention;

FIG. 5 is a schematic diagram of a gain curve and a beam deflection angle of the dual-band polarized two-beam base station antenna in the embodiment 1 of the present invention;

FIG. 6a is a schematic three-dimensional structural diagram of a dual-band polarized two-beam base station antenna in an embodiment 2 of the present invention;

FIG. 6b is a schematic cross-sectional view of the dual-band polarized two-beam base station antenna in the embodiment 2 of the present invention;

FIG. 7a is a top view of an upper surface of a radiation metasurface antenna layer in the embodiment 2 of the present invention;

FIG. 7b is a bottom view of a lower surface of the radiation metasurface antenna layer in the embodiment 2 of the present invention;

FIG. 7c is a top view of an upper surface of a metal floor in the embodiment 2 of the present invention;

FIG. 7d is a top view of a stripline layer of a four-port feed network in the embodiment 2 of the present invention;

FIG. 7e is a bottom view of a lower surface of a four-port feed network layer in the embodiment 2 of the present invention;

FIG. 8 is a schematic diagram of an S parameter of the dual-band polarized two-beam base station antenna in the embodiment 2 of the present invention;

FIG. 9 is a yoz plane pattern of the dual-band polarized two-beam base station antenna at 4.9 GHz in the embodiment 2 of the present invention; and

FIG. 10 is a schematic diagram of a gain curve and a beam deflection angle of the dual-band polarized two-beam base station antenna in the embodiment 2 of the present invention;

### DETAILED DESCRIPTION OF EMBODIMENTS

The specific implementation of the present invention is further described in detail below in conjunction with the embodiments and the accompanying drawings, but the implementation of the present invention is not limited thereto.

### Embodiment 1

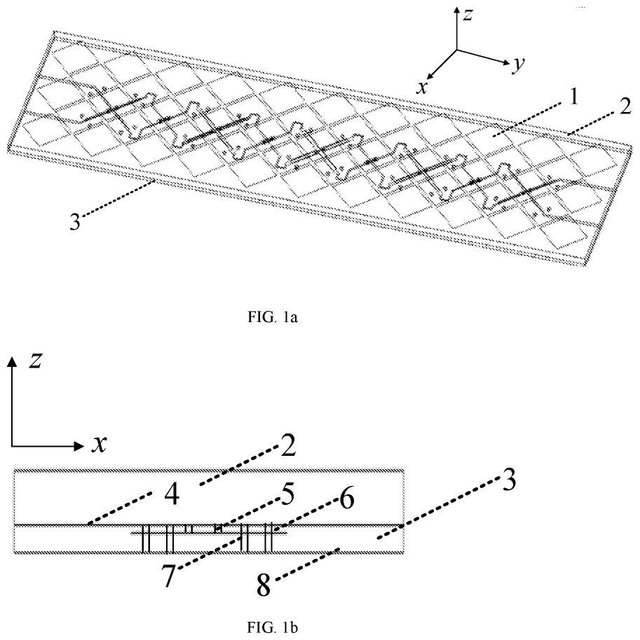

As shown in FIG. 1a and FIG. 1b, a metasurface-based miniaturized dual-band polarized two-beam base station antenna includes a radiation metasurface antenna layer 2, a metal floor 4 etched with a plurality of crossed slots 9, and a four-port feed network layer 3; the radiation metasurface antenna layer 2 is positioned on an uppermost layer, the four-port feed network layer 3 is positioned on a lowermost layer, the metal floor 4 is arranged between the radiation metasurface antenna layer 2 and the four-port feed network layer 3, and the plurality of crossed slots 9 are etched on the metal floor 4 to achieve a dual-band polarized radiation characteristic; the plurality of crossed slots 9 are sequentially excited, and energy of the four-port feed network layer 3 is coupled to the radiation metasurface antenna layer 2 via the crossed slots 9, so as to achieve dual-band polarized beams.

Both the radiation metasurface antenna layer 2 and the four-port feed network layer 3 adopt printed circuit board (PCB) dielectric substrates. An X-axis direction of the dielectric substrate is a vertical direction, a Y-axis direction of the dielectric substrate is a horizontal direction, and an origin of the dielectric substrate is a center point of the dielectric substrate. An XY coordinate system direction mentioned in this embodiment is subject to the accompanying drawing.

A dielectric constant εᵣ of the PCB ranges from 2.2 to 10.2, and a thickness of the PCB ranges from 0.01λ to 0.3λ; and a thickness of the metal floor ranges from 0.005λ to 0.1λ, where λ is a free space wavelength.

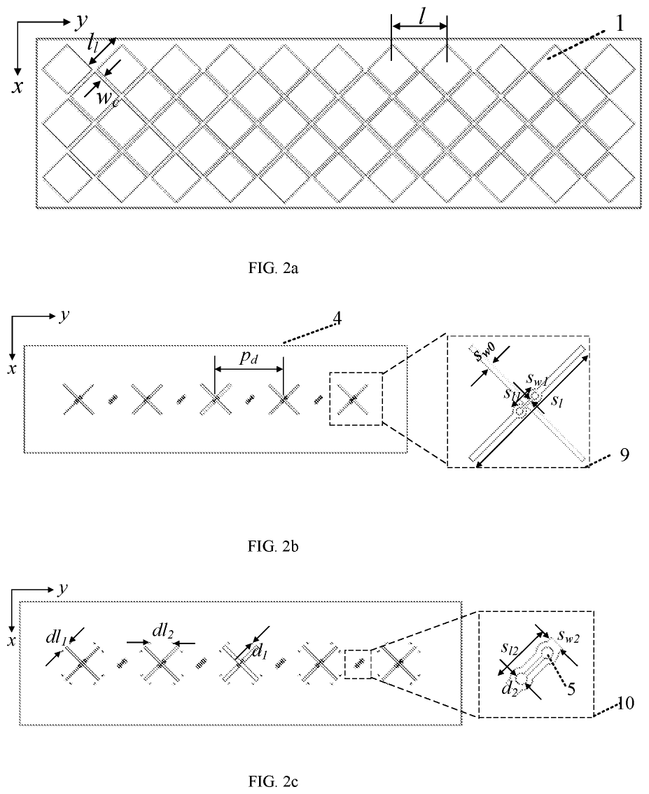

As shown in FIG. 2a, in this embodiment, a radiation patch structure is printed on an upper surface of the radiation metasurface antenna layer 2, and the radiation patch structure includes a plurality of periodically arranged metasurface elements 1 that are square patches in type.

As shown in FIG. 2b, in the metal floor 4, a spacing between every two adjacent crossed slots 9 is equal, a shape of each crossed slot 9 may be different, and a size and shape of the crossed slot 9 are selected as needed to adjust impedance matching and beam characteristics.

FIG. 2c and FIG. 2d, a four-port feed network 6 is arranged in a middle of the four-port feed network layer 3. In this embodiment, the four-port feed network 6 includes four input ports and mutually crossed transmission lines; a first input port 11 and a second input port 12 are respectively placed at two ends of the four-port feed network 6 and respectively correspond to two deflected beams of 45° polarization, and a third input port 13 and a fourth input port 14 are respectively placed at two ends of the four-port feed network 6 and respectively correspond to two deflected beams of −45° polarization; a part of the transmission lines of the four-port feed network 6 between the slots is provided with a bent structure 15; and the bent structure 15 is adjusted according to a beam deflection angle, one metal bridge joint 10 is arranged at an intersection of the transmission lines of the four-port feed network 6, the metal bridge joint 10 is rotationally symmetrical about the intersection of the transmission lines, and two metal half through holes 5 are provided in two ends of the metal bridge joint 10 for signal transmission.

As shown in FIG. 2c, FIG. 2d, and FIG. 2e, in this embodiment, four pairs of symmetrically distributed metal through holes 7 are provided around the crossed slots 9, and the metal through holes 7 are connected to a lower bottom surface of the metal floor 4 and a lower bottom surface of the four-port feed network layer 3.

In this embodiment, the transmission line of the four-port feed network 6 is in the form of a stripline.

As shown in FIG. 2a, a size lₗ of the patch of the metasurface element 1 ranges from 0.1λ to 0.25λ, a cycle l of the patch ranges from 0.1λ to 0.35λ, and a slot width w_{c} between the patches ranges from 0.001λ to 0.02λ. As shown in FIG. 2b, a length sₗ of the slot etched on the metal floor 4 ranges from 0.1λ to 0.7λ, a width s_{w0} of the crossed slot 9 etched on the metal floor 4 ranges from 0.01λ to 0.1λ, a length sₗ₁ of the metal bridge joint in the slot etched on the metal floor ranges from 0.05λ to 0.5λ, a width s_{w1} of the metal bridge joint in the crossed slot 9 etched on the metal floor 4 ranges from 0.01λ to 0.1λ, a cycle P_{d} of the crossed slot 9 etched on the metal floor 4 ranges from 0.05λ to 1λ, a length sₗ₂ of the metal bridge joint 10 etched on the metal floor 4 ranges from 0.05λ to 0.5λ, a width s_{w2} of the metal bridge joint 10 etched on the metal floor ranges from 0.01λ to 0.1λ, a diameter d₂ of each of the metal half through holes 5 provided in the two ends of the metal bridge joint 10 ranges from 0.001λ to 0.1λ, a diameter d₁ of each of the metal through holes 7 around the crossed slots 9 etched on the metal floor 4 ranges from 0.001λ to 0.1λ, a width f_{w0} of the transmission line ranges from 0.001λ to 0.1λ, and a total length (fl₀+fl₁+fl₂) of the bent transmission line 15 ranges from 0.1λ to 1.5λ, where λ is the free space wavelength.

In this embodiment, a metasurface-based miniaturized dual-band polarized two-beam base station antenna has a specific size as follows:

A dielectric constant εᵣ of the radiation metasurface antenna layer 2 is 4.4, and a thickness of the radiation metasurface antenna layer 2 is 2 mm; and a dielectric constant εᵣ of the four-port feed network layer 3 is 2.2 and a thickness of the four-port feed network layer 3 is 1 mm. The size lₗ of the square patch of the metasurface element 1 is 8.5 mm, the cycle l of the square patch is 13.85 mm, the width w_{c} of the slot between the patches is 1.25 mm, the length sₗ of each of the five crossed slots 9 is 18 mm, the width sw₀ of the slot is 1.2 mm, the length sₗ₁ of the metal bridge joint in the crossed slot 9 etched on the metal floor 4 is 4.5 mm, the width s_{w1} of the metal bridge joint in the crossed slot 9 etched on the metal floor 4 is 0.5 mm, the cycle P_{d} of the crossed slot 9 etched on the metal floor 4 is 28 mm, the length sₗ₂ of the metal bridge joint 10 etched on the metal floor 4 is 4.5 mm, the width s_{w2} of the metal bridge joint 10 etched on the metal floor 4 is 0.5 mm, the diameter d₂ of the metal half through hole 5 provided in the metal bridge joint 10 is 0.45 mm, the diameter d₁ of each of the metal through holes 7 around the crossed slots 9 etched on the metal floor 4 is 0.45 mm, the width f_{w0} of the feed stripline is 0.7 mm, and the total length (fl₀+fl₁+fl₂) of the bent part is 7 mm.

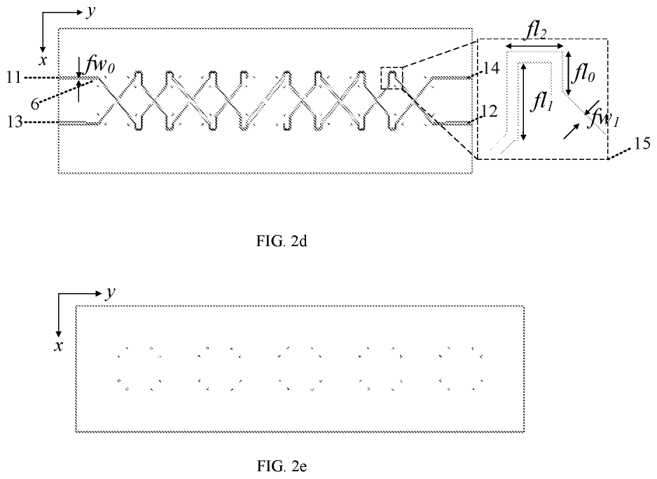

As shown in FIG. 3, a metasurface-based miniaturized dual-band polarized two-beam base station antenna has a working band ranging from 4.6 GHz to 5.3 GHz, in-band S11 lower than −10 dB, in-band co-polarization isolation greater than 10 dB, and in-band cross-polarization isolation greater than 15 dB.

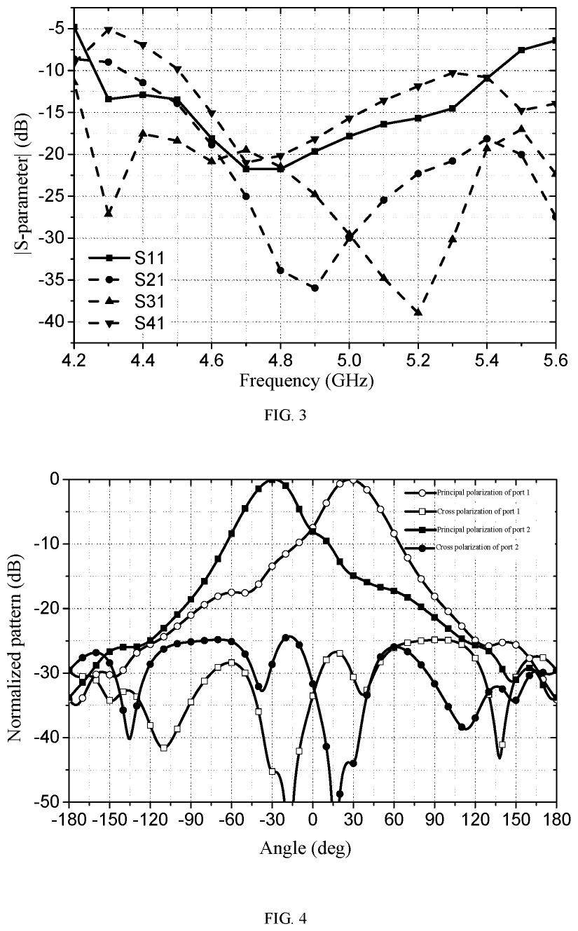

As shown in FIG. 4, a frequency of 4.9 GHz is selected, a radiation pattern of the port 1 points to 30 deg, a radiation pattern of the port 2 points to −30 deg, the patterns corresponding to the two ports have better symmetry along a Z axis, a cross polarization level is lower than −24 dB, and a front-to-back ratio is greater than 25 dB.

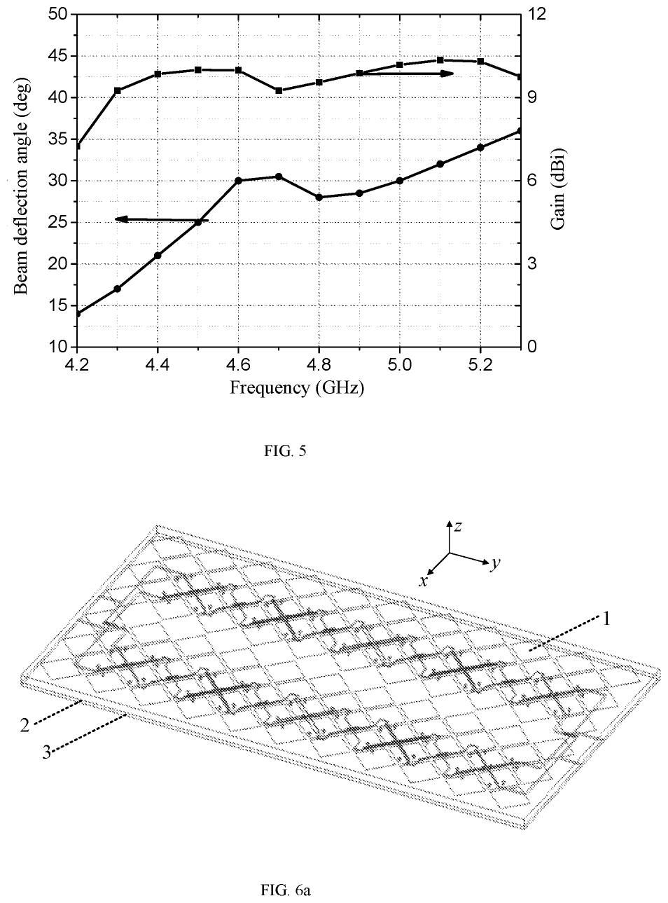

As shown in FIG. 5, since the four ports have better symmetry, only a gain curve and beam pointing of the port 1 need to be examined. At a band ranging from 4.6 GHz to 5.1 GHz, an in-band gain is greater than 9 dBi, and the beam pointing ranges from 27.5 deg to 32.5 deg; and when the in-band gain is flat, the beam pointing is stable.

It may be seen from the above that the dual-band polarized two-beam base station antenna in this embodiment may effectively realize the characteristics of miniaturization, dual-band polarization, and two beams, and has the better consistency of the beam deflection angle in the working band.

### Embodiment 2

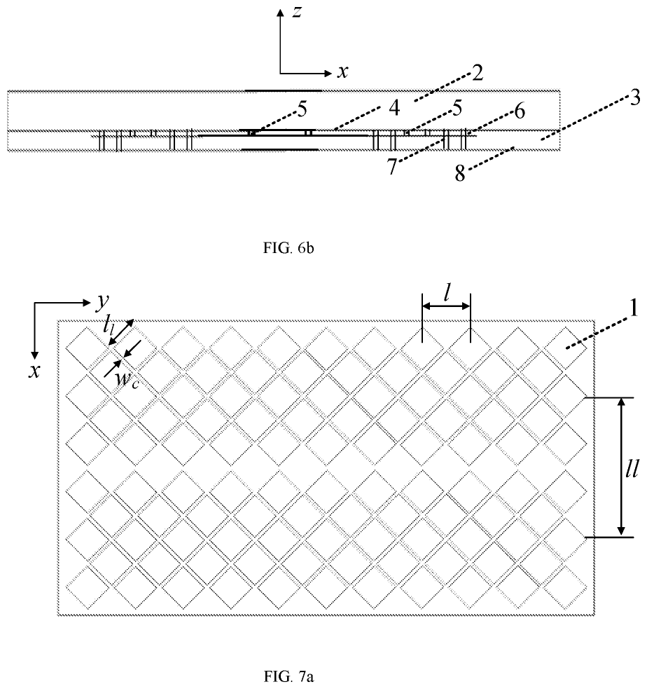

A metasurface-based high-gain dual-band polarized two-beam base station antenna is based on a dual-polarization element in Embodiment 1. To increase an antenna gain, binary arraying is implemented in an x-axis direction, and two input ports of the same polarization and the same beam are respectively connected to each other via a one-to-two power divider. As shown in FIG. 6a and FIG. 6b, the antenna includes a radiation metasurface antenna layer 2, a metal floor 4 etched with a plurality of crossed slots 9, and a four-port feed network layer 3; the radiation metasurface antenna layer 2 is positioned on an uppermost layer, the four-port feed network layer 3 is positioned on a lowermost layer, the metal floor 4 is arranged between the radiation metasurface antenna layer 2 and the four-port feed network layer 3, and the plurality of crossed slots 9 are etched on the metal floor 4 to achieve a dual-band polarized radiation characteristic; the plurality of crossed slots 9 are sequentially excited, and energy of the four-port feed network layer 3 is coupled to the radiation metasurface antenna layer 2 via the crossed slots 9, so as to realize dual-band polarized beams.

Both the radiation metasurface antenna layer 2 and the four-port feed network layer 3 adopt PCB dielectric substrates. An X-axis direction of the dielectric substrate is a vertical direction, a Y-axis direction the dielectric substrate is a horizontal direction, and an origin the dielectric substrate is a center point of the dielectric substrate. An XY coordinate system direction mentioned in this embodiment is subject to the accompanying drawing.

A dielectric constant εᵣ of the PCB ranges from 2.2 to 10.2, and a thickness of the PCB ranges from 0.01λ to 0.3λ; and a thickness of the metal floor ranges from 0.005λ to 0.1λ, where λ is a free space wavelength.

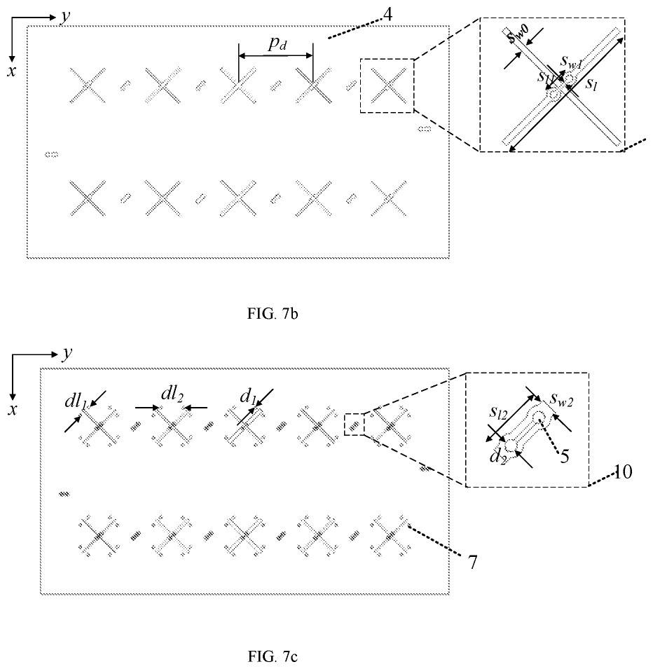

As shown in FIG. 7a, in this embodiment, a radiation patch structure is printed on an upper surface of the radiation metasurface antenna layer 2, and the radiation patch structure is arranged in array on an x axis.

As shown in FIG. 7b, in the metal floor 4, a spacing between every two adjacent crossed slots 9 is equal, a shape of each crossed slot 9 may be different, and a size and shape of the crossed slot 9 are selected as needed to adjust impedance matching and beam characteristics.

FIG. 7c and FIG. 7d, a four-port feed network 6 is arranged in a middle of the four-port feed network layer 3. In this embodiment, the four-port feed network 6 includes four input ports and mutually crossed transmission lines; a first input port 11 and a second input port 12 are respectively placed at two ends of the four-port feed network 6 and respectively correspond to two deflected beams of 45° polarization, and a third input port 13 and a fourth input port 14 are respectively placed at two ends of the four-port feed network 6 and respectively correspond to two deflected beams of −45° polarization; a part of the transmission lines of the four-port feed network 6 between the slots is provided with a bent structure 15; and the bent structure 15 is adjusted according to a beam deflection angle, one metal bridge joint 10 is arranged at an intersection of the transmission lines of the four-port feed network 6, the metal bridge joint 10 is rotationally symmetrical about the intersection of the transmission lines, and two metal half through holes 5 are provided in two ends of the metal bridge joint 10 for signal transmission.

As shown in FIG. 7c, FIG. 7d, and FIG. 7e, in this embodiment, four pairs of symmetrically distributed metal through holes 7 are provided around the crossed slots 9, and the metal through holes 7 are connected to a lower bottom surface of the metal floor 4 and a lower bottom surface of the four-port feed network layer 3.

In this embodiment, the transmission line of the four-port feed network 6 is in the form of a stripline.

As shown in FIG. 7a, a cycle ll of a dual-polarized base station antenna element ranges from 0.4λ to 2λ, a size lₗ of the patch of the metasurface element 1 ranges from 0.1λ to 0.25λ, a cycle l of the patch ranges from 0.1λ to 0.35λ, and a slot width w_{c} between the patches ranges from 0.001λ to 0.02λ. As shown in FIG. 2b, a length sₗ of the slot etched on the metal floor 4 ranges from 0.1λ to 0.7λ, a width s_{w0} of the crossed slot 9 etched on the metal floor 4 ranges from 0.01λ to 0.1λ, a length sₗₗ of the metal bridge joint in the crossed slot 9 etched on the metal floor ranges from 0.05λ to 0.5λ, a width s_{w1} of the metal bridge joint in the crossed slot 9 etched on the metal floor 4 ranges from 0.01λ to 0.1λ, a cycle P_{d} of the crossed slot 9 etched on the metal floor 4 ranges from 0.05λ to 1λ, a length sₗ₂ of the metal bridge joint 10 etched on the metal floor 4 ranges from 0.05λ to 0.5λ, a width s_{w2} of the metal bridge joint 10 etched on the metal floor ranges from 0.01λ to 0.1λ, a diameter d₂ of each of the metal half through holes 5 provided in the two ends of the metal bridge joint 10 ranges from 0.001λ to 0.1λ, a diameter d₁ of each of the metal through holes 7 around the crossed slots 9 etched on the metal floor 4 ranges from 0.001λ to 0.1λ, a width f_{w0} of the transmission line ranges from 0.001λ to 0.1λ, and a total length (fl₀+fl₁+fl₂) of the bent transmission line 15 ranges from 0.1λ to 1.5λ, where λ is the free space wavelength.

In this embodiment, a metasurface-based high-gain dual-band polarized two-beam base station antenna has a specific size as follows:

A dielectric constant εᵣ of the radiation metasurface antenna layer 2 is 4.4, and a thickness of the radiation metasurface antenna layer 2 is 2 mm; and a dielectric constant εᵣ of the four-port feed network layer 3 is 2.2 and a thickness of the radiation metasurface antenna layer 2 is 1 mm. The cycle ll of the dual-polarized base station antenna element is 40.7 mm, the size lₗ of the square patch of the metasurface element 1 is 8.5 mm, the cycle l of the square patch is 13.85 mm, and the width w_{c} of the slot between the patches is 1.25 mm; the length sₗ of each of two pairs of the five crossed slots 9 is 18 mm, the width sw₀ of the crossed slot 9 is 1.2 mm, the length sₗ₁ of the metal bridge joint in the crossed slot 9 etched on the metal floor 4 is 4.5 mm, the width s_{w1} of the metal bridge joint in the crossed slot 9 etched on the metal floor 4 is 0.5 mm, the cycle P_{d} of the crossed slot 9 etched on the metal floor 4 is 28 mm, the length sₗ₂ of the metal bridge joint 10 etched on the metal floor 4 is 4.5 mm, the width s_{w2} of the metal bridge joint 10 etched on the metal floor 4 is 0.5 mm, the diameter d₂ of the metal half through hole 5 provided in the metal bridge joint 10 is 0.45 mm, and the diameter d₁ of each of the metal through holes 7 around the crossed slots 9 etched on the metal floor 4 is 0.45 mm; and the width f_{w0} of the feed stripline is 0.7 mm, and the total length (fl₀+fl₁+fl₂) of the bent part is 7 mm.

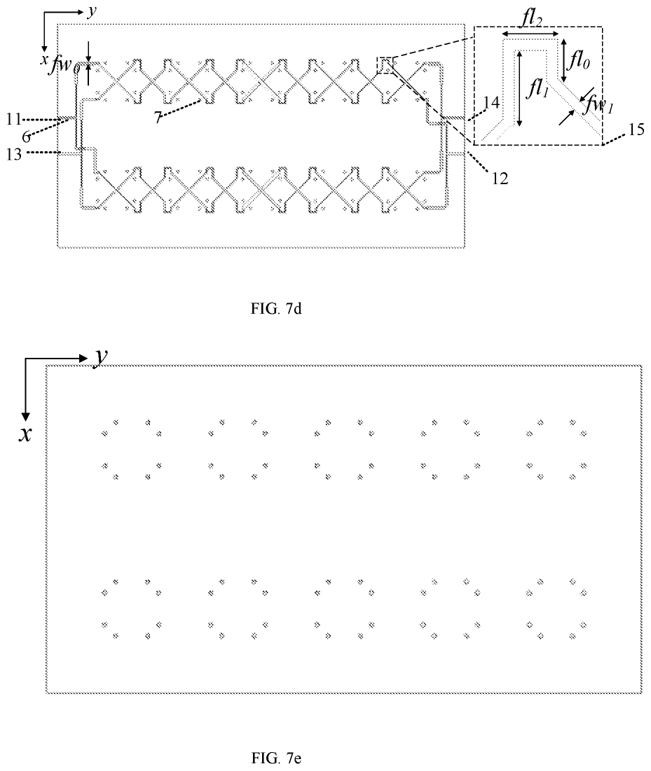

As shown in FIG. 8, a metasurface-based high-gain dual-band polarized two-beam base station antenna has a working band ranging from 4.6 GHz to 5.4 GHz, in-band S11 lower than −10 dB, in-band co-polarization isolation greater than 10 dB, and in-band cross-polarization isolation greater than 15 dB.

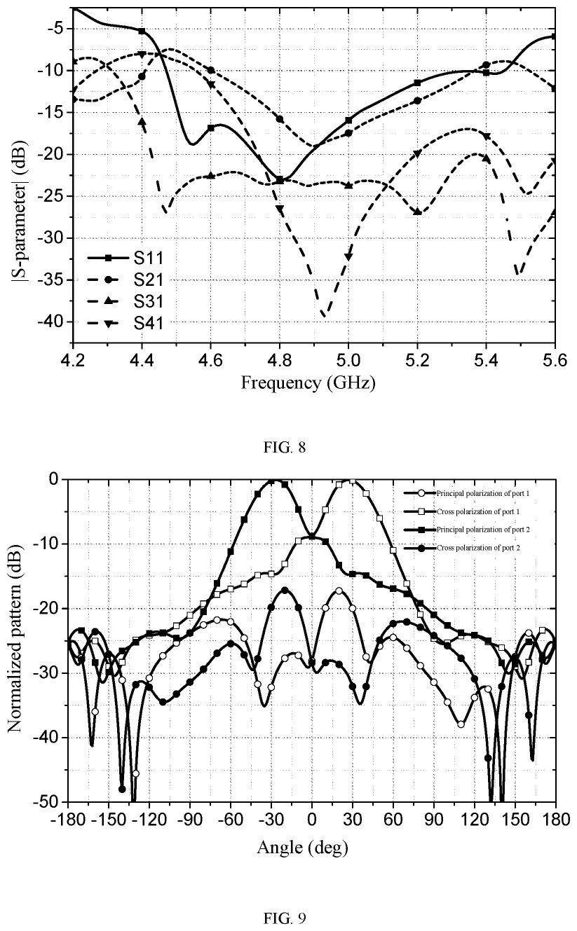

As shown in FIG. 9, a frequency of 4.9 GHz is selected, a radiation pattern of the port 1 points to 30 deg, a radiation pattern of the port 2 points to −30 deg, the patterns corresponding to the two ports have better symmetry along a Z axis, a cross polarization level is lower than −17 dB, and a front-to-back ratio is greater than 25 dB.

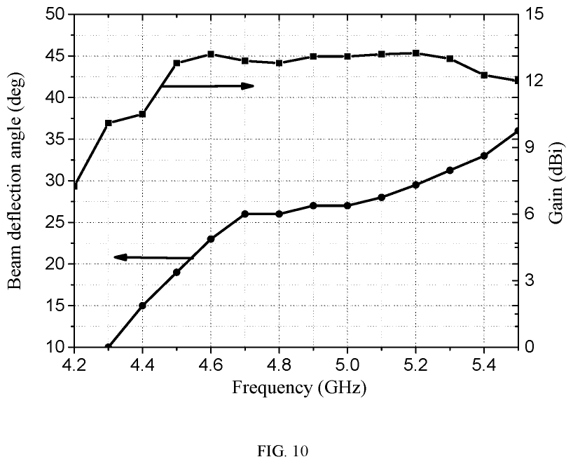

As shown in FIG. 10, since the four ports have better symmetry, only a gain curve and beam pointing of the port 1 need to be examined. At a band ranging from 4.6 GHz to 5.3 GHZ, an in-band gain is greater than 12 dBi, and the beam pointing ranges from 25.5 deg to 32.5 deg; and when the in-band gain is flat, the beam pointing is stable.

It may be seen from the above that the dual-band polarized two-beam base station antenna in this embodiment may effectively realize the characteristics of high gain, dual-band polarization, and two beams, and has the better consistency of the beam deflection angle in the working band.

The above embodiments are the preferred embodiments of the present invention, but the implementation of the present invention is not limited by the embodiments. Any other changes, modifications, substitutions, combinations, and simplifications made without deviating from the spirit and principle of the present invention should be equivalent substitutions, and are included in the scope of protection of the present invention.

1. A metasurface-based dual-band polarized two-beam base station antenna, comprising a radiation metasurface antenna layer, a metal floor etched with a plurality of crossed slots, and a four-port feed network layer, wherein the radiation metasurface antenna layer is positioned on an uppermost layer, the four-port feed network layer is positioned on a lowermost layer, the metal floor is arranged between the radiation metasurface antenna layer and the four-port feed network layer, and the plurality of crossed slots are etched on the metal floor to achieve a dual-band polarized radiation characteristic; the plurality of crossed slots are sequentially excited, and energy of the four-port feed network layer is coupled to the radiation metasurface antenna layer via the crossed slots, so as to achieve dual-band polarized beams;
a four-port feed network is arranged in a middle of the four-port feed network layer; the four-port feed network comprises four input ports and mutually crossed transmission lines; a first input port and a second input port are respectively placed at two ends of the four-port feed network and respectively correspond to two deflected beams of one polarization, and a third input port and a fourth input port are respectively placed at two ends of the four-port feed network and respectively correspond to two deflected beams of another orthogonal polarization; a part of the transmission lines of the four-port feed network between the slots is provided with a bent structure; and the bent structure is adjusted according to a beam deflection angle, one metal bridge joint is arranged at an intersection of the transmission lines of the four-port feed network, the metal bridge joint is rotationally symmetrical about the intersection of the transmission lines, and two metal half through holes are provided in two ends of the metal bridge joint for signal transmission.

2. The metasurface-based dual-band polarized two-beam base station antenna according to claim 1, wherein, a radiation patch structure is printed on an upper surface of the radiation metasurface antenna layer, and the radiation patch structure comprises a plurality of metasurface elements; the metasurface elements adopt rectangular patches or cross patches; and
the metasurface elements are arranged periodically or aperiodically.

3. (canceled)

4. The metasurface-based dual-band polarized two-beam base station antenna according to claim 1, wherein in the metal floor, a spacing between adjacent two of the crossed slots is equal, and a size and shape of each of the crossed slots are selected as needed to adjust impedance matching and beam characteristics.

5. (canceled)

6. The metasurface-based dual-band polarized two-beam base station antenna according to claim 1, wherein symmetrically distributed metal through holes are provided around the crossed slots, and the metal through holes are connected to a lower bottom surface of the metal floor and a lower bottom surface of the four-port feed network layer.

7. The metasurface-based dual-band polarized two-beam base station antenna according to claim 1, wherein the transmission lines of the four-port feed network adopt microstrip lines, striplines, or substrate integrated waveguide transmission structures.

8. The metasurface-based dual-band polarized two-beam base station antenna according to claim 1, wherein polarization corresponding to the four input ports arranged in the four-port feed network comprises ±45° linear polarization or vertical/horizontal linear polarization.

9. The metasurface-based dual-band polarized two-beam base station antenna according to claim 1, wherein the number of crossed slots on the metal floor is adjusted freely as needed; when no more than five slots are used, the antenna has an advantage of miniaturization under the condition of ensuring dual-band polarized two-beam property; and when more than five slots are used or when arranged in array, the antenna has advantages of high isolation, narrow beam, and high gain under the condition of ensuring the dual-band polarized two-beam property.

10. The metasurface-based dual-band polarized two-beam base station antenna according to claim 9, wherein both the radiation metasurface antenna layer and the four-port feed network layer adopt printed circuit board (PCB) dielectric substrates.
